(19) United States
(12) Patent Application Publication
(10) Pub. No.: US 2026/0296835 A1
(43) Pub. Date: Oct. 1, 2026

(54) CABLE TENSIONING SYSTEM FOR MODULAR STAIRLIFTS

(71) Applicant: LeafFilter North, LLC, Hudson, OH (US)

(72) Inventors: Jason Crowell, Akron, OH (US); RuQing Liu, Cuyahoga Falls, OH (US); Michael Gori, Norton, OH (US)

(73) Assignee: LeafFilter North, LLC, Hudson, OH (US)

(21) Appl. No.: 19/702,085

(22) Filed: Jun. 9, 2026

Related U.S. Application Data
(63) Continuation-in-part of application No. 18/620,227, filed on Mar. 28, 2024, now Pat. No. 12,673,848.
(60) Provisional application No. 63/492,921, filed on Mar. 29, 2023.

(51) Int. Cl. B66B 9/08; B66B 19/00

(52) U.S. Cl. CPC B66B 9/0846; B66B 19/00

(57) ABSTRACT

A cable tensioning system includes an adjustable cable having a first end and a second end, and a plurality of coupling point defined thereon. The adjustable cable is configured to extend through a plurality of assembled components arranged in series along an axis. An adjustment system includes an anchor assembly coupled to the first end of the adjustable cable and a tension assembly coupled to one coupling point of the plurality of coupling point. The adjustment system is configured to be adjusted to adjust a tension force in the adjustable cable so as to draw the plurality of assembled components together and apply a resulting compressive force thereon sufficient to impart a structural rigidity to the assembled components.

### CROSS-REFERENCE TO RELATED APPLICATIONS

This application is a continuation-in-part of U.S. patent application Ser. No. 18/620,227, titled “Stair Lift Systems and Method for Assembling, Installing, and Using Such Systems,” filed Mar. 28, 2024, which claims the benefit of U.S. Provisional Patent Application Ser. No. 63/492,921, titled “Stair Lift Systems and Methods for Assembling, Installing, and Using such Systems,” filed Mar. 29, 2023. The disclosures of each prior application are hereby incorporated by reference in their entireties.

### FIELD OF INVENTION

The present disclosure generally relates to stair lift systems comprising configurable subcomponents and methods for assembling such subcomponents into a stair lift system, installing such stair lift systems, and using such stair lift systems. More specifically, the present disclosure relates to stair lift systems having cable tensioning systems for use with a modular rail.

### BACKGROUND

In recent years, the requirements and demands of the residential home remodeling and home improvement markets have evolved to include a broader demographic and an ever-growing variety of services. Traditionally, most consumers justified the cost of remodeling a home because remodeling increases the value of the home, repairs defects to the home, improves energy efficiency, and/or updates the aesthetic styling and amenities of the home. However, with the increased aging of the world's population, particularly in industrialized countries, more and more consumers are remodeling homes to satisfy aging consumers' desires to safely remain in their homes longer despite physical limitations that come with aging. The same can be said for younger consumers that either through injury or disease have physical limitations. The general trend is that consumers want to remain independent and in their familiar home environment as long as possible. In addition to the understandable desire to continue to live independently, the cost of in-home care, assisted living facilities, and other such alternatives often provide an economic incentive for aging consumers to remodel their residential homes to safely accommodate consumers with physical limitations.

As noted, today's older consumers are more independent and commonly choose to remain in their residential home much longer than prior generations. In one estimate, the number of Americans over the age of 65 will increase from 54 million in 2020 to 80 million in 2040, which includes a more than doubling of Americans over the age of 85 from 7 million to 15 million. This growth in the number of aging Americans has a proportional effect on the number of homeowners over the age of 65. In the last decade, the number of homeowners over the age of 65 has increased by 9 million, and it is expected that this number will grow by an additional 19.3 million persons in the next decade. As the population ages, many more home remodeling projects will focus on making the home safer for aging, particularly those with mobility limitations, that desire to remain in their homes. Even today, 45% of consumers cite making a home safer and more useable for an aging resident as one of the reasons for remodeling a home. This percentage is sure to grow in the coming years.

While there are often many projects required to make a home safe and efficient for an aging resident, transforming a two or more-story home into a space that is accessible for those with mobility issues may be of utmost importance. For any aging person to remain in his or her residential home, rather than moving to a single-story dwelling or foregoing the additional living space above or below the ground floor, it is important to facilitate movement between a first and second floor of the home or the first floor and basement of the home. One method of accommodating this need is to install a stair lift system that allows a user to sit in a chair and be transported up a staircase using a complicated stair rail system. In most cases, the stair rail system is custom-built for each homeowner's unique staircase. Often custom-built stair rail systems are required because of the wide variety and variations of staircases that can be found in homes. These variations are driven by many factors such as the age of a home, architecture style of a home, and local or regional home builder preferences, practices, and regulations. This often results in long lead times and delays between a consumer contacting a stair lift provider and the successful installation in the stair lift in the consumer's home. Between the first contact and the successful installation, the stair lift provider must visit the home, take a number of measurements, provide an estimate and quote to the consumer, the manufacturer must custom make the stair lift system, and the stair lift provider must install the stair lift system in the customer's home. And if any component of the customized system is not manufactured specifically to the custom specifications or there is an error in the initial measurements, there may need to be reworking or remanufacturing of such components. Such a process may last several weeks or even several months, which results in the consumer remaining confined to one floor of the home or remaining confined to an assisted living facility until that multi-step process is completed.

The long process of custom designing and building a traditional stair lift system can last several weeks or even several months, which becomes an even more apparent problem when a consumer's quality of life is degraded because of the inability to access the full extent of their home. Further, in certain situations, a consumer is unable to be released from a hospital, nursing home, or other caregiving facility without having the proper stair lift system in their home so that they can safety navigate their independent living situation. Often, a consumer does not realize they need a stair lift system until an occurrence of a debilitating event, such as a fall for example. Once such a debilitating event occurs the consumer needs an adequate stair lift system nearly immediately. The consumer does not have several weeks or several months to wait for a custom stair lift system to be built and installed. In essence, the consumer is at the mercy of the current slow and error prone ordering and installation processes.

Therefore, it is desirable to develop a more efficient approach to the design, fabrication, delivery, and installation of stair lift systems that offers flexibility and variability in configuration and arrangement so as to require a short period of time between the placement of a consumer order for a stair lift system and the installation of that system in a consumer's home. Such an efficient approach is needed to meet the market's demands for installing stair lift systems in a wide variety of stairways and staircases configurations at a reasonable cost without unnecessarily extending the overall project schedule.

### SUMMARY

In some embodiments, a cable tensioning system includes an adjustable cable having a first end and a second end, and a plurality of coupling point defined thereon. The adjustable cable is configured to extend through a plurality of assembled components arranged in series along an axis. An adjustment system includes an anchor assembly coupled to the first end of the adjustable cable and a tension assembly coupled to one coupling point of the plurality of coupling point. The adjustment system is configured to be adjusted to adjust a tension force in the adjustable cable so as to draw the plurality of assembled components together and apply a resulting compressive force thereon sufficient to impart a structural rigidity to the assembled components.

In some embodiments, a method of assembling a modular rail by an internal cable includes providing an adjustable cable, the adjustable cable including an anchor assembly disposed at a first end of the adjustable cable and a series of ball shanks spaced at predetermined intervals along a portion of the adjustable cable at an opposing second end of the adjustable cable, the ball shanks being a plurality of coupling points. The method includes coupling a tensioning assembly to a last ball shank of the series of ball shanks. The method includes inserting the adjustable cable within an internal cavity of a modular rail made of a plurality of rail segments arranged in series, such that the tensioning assembly engages a first end of the modular rail and the anchor assembly engages a second end of the modular rail. The method includes adjusting the anchor assembly to remove slack from the adjustable cable and draw the plurality of rail segments tight to each other in series to provide structural rigidity to the modular rail. The method includes adjusting the tensioning assembly to increase a tension of the adjustable cable and to increase a compression on the modular rail to impart structural rigidity in the modular rail.

### BRIEF DESCRIPTION OF THE DRAWINGS

In the accompanying drawings, structures are illustrated that, together with the detailed description provided below, describe example embodiments of the disclosed apparatus and methods. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 is a schematic representation of a modular rail assembly for use with a stair lift system.

FIG. 2 illustrates a prior art stair lift system.

FIG. 3 is a perspective view of a variety of components useful in assembling an embodiment of a modular rail assembly for use with a stair lift system.

FIG. 4 schematically illustrates a cable tensioning assembly for use with stair lift systems.

FIG. 5 schematically illustrates a series of ball shanks secured to a cable of the cable tensioning assembly of FIG. 4.

FIG. 6 schematically illustrates a tensioning assembly of the cable tensioning assembly of FIG. 4.

FIG. 7 schematically illustrates a perspective view of the tensioning bolt of the cable tensioning assembly of FIG. 4.

FIG. 8 schematically illustrates another perspective view of the tensioning bolt of the cable tensioning assembly of FIG. 4.

FIG. 9 schematically illustrates a side plan view of the tensioning bolt of the cable tensioning assembly of FIG. 4.

FIG. 10 schematically illustrates the tensioning assembly of the cable tensioning assembly of FIG. 4 with a transparent tensioning rail extension.

FIG. 11 schematically illustrates a portion of an anchoring tensioning assembly of the cable tensioning assembly of FIG. 4.

FIG. 12 schematically illustrates the anchoring assembly of the cable tensioning assembly of FIG. 4.

FIG. 13 schematically illustrates the anchoring assembly of the cable tensioning assembly of FIG. 4 with a transparent anchor rail extension.

FIG. 14 schematically illustrates a perspective view of a tensioning assembly secured to a terminal post.

FIG. 15 schematically illustrates a plan side view of the tensioning assembly secured to a terminal post.

FIG. 16 schematically illustrates a cross-sectional view of the tensioning assembly secured to a terminal post.

FIG. 17 schematically illustrates an exploded view of the tensioning assembly secured to a terminal post.

FIG. 18 schematically illustrates a perspective view of a rail connector.

FIG. 19 schematically illustrates a perspective view of a tensioning end stop adaptor.

FIG. 20 schematically illustrates a perspective view of a tensioning end stop.

FIG. 21 schematically illustrates a perspective view of a tensioning rail extension and a tensioning bolt cap.

FIG. 22 schematically illustrates a perspective view of an anchoring assembly secured to a terminal post.

FIG. 23 schematically illustrates a plan side view of the anchoring assembly secured to a terminal post.

FIG. 24 schematically illustrates a cross-sectional view of the anchoring assembly secured to a terminal post.

FIG. 25 schematically illustrates an exploded view of the anchoring assembly secured to a terminal post.

FIG. 26 schematically illustrates a perspective view of a rail connector.

FIG. 27 schematically illustrates a perspective view of an anchoring end stop adapter.

FIG. 28 schematically illustrates a perspective view of an anchoring end stop.

FIG. 29 schematically illustrates a perspective view of an anchoring bolt cap.

FIG. 30 schematically illustrates a perspective view of the tensioning assembly secured to a terminal post with the tensioning end cap unassembled.

FIG. 31 schematically illustrates a side view of the tensioning assembly secured to a terminal post with the tensioning end cap assembled.

FIG. 32 schematically illustrates a perspective view of the anchoring assembly secured to a terminal post with the anchoring end cap unassembled.

FIG. 33 schematically illustrates a side view of the anchoring assembly secured to a terminal post with the tensioning end cap assembled.

### DETAILED DESCRIPTION

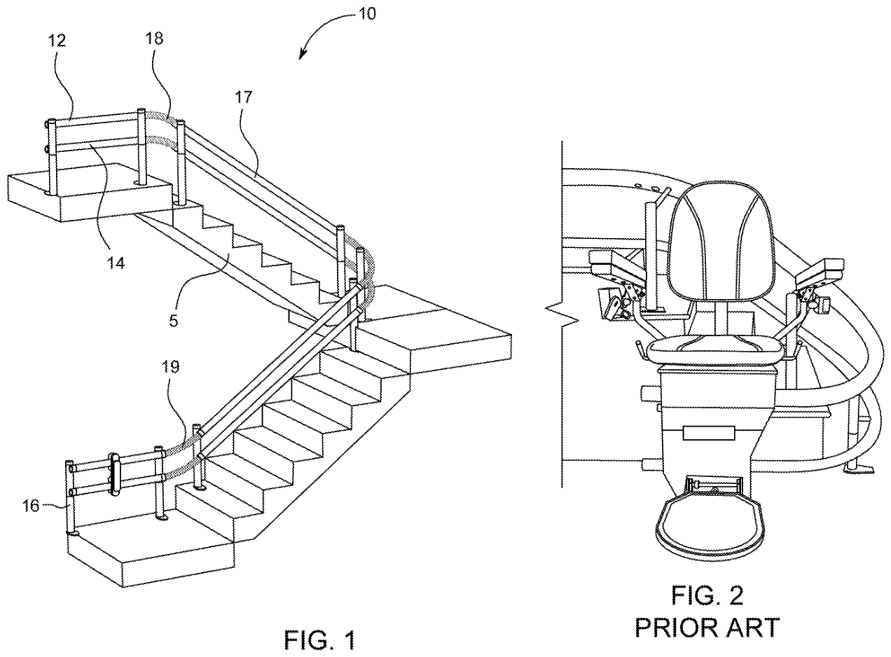

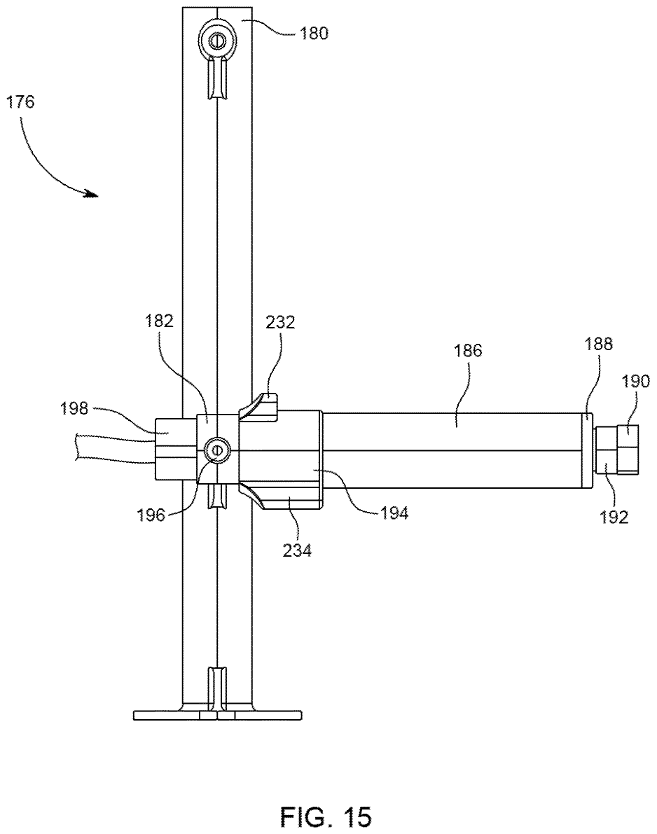

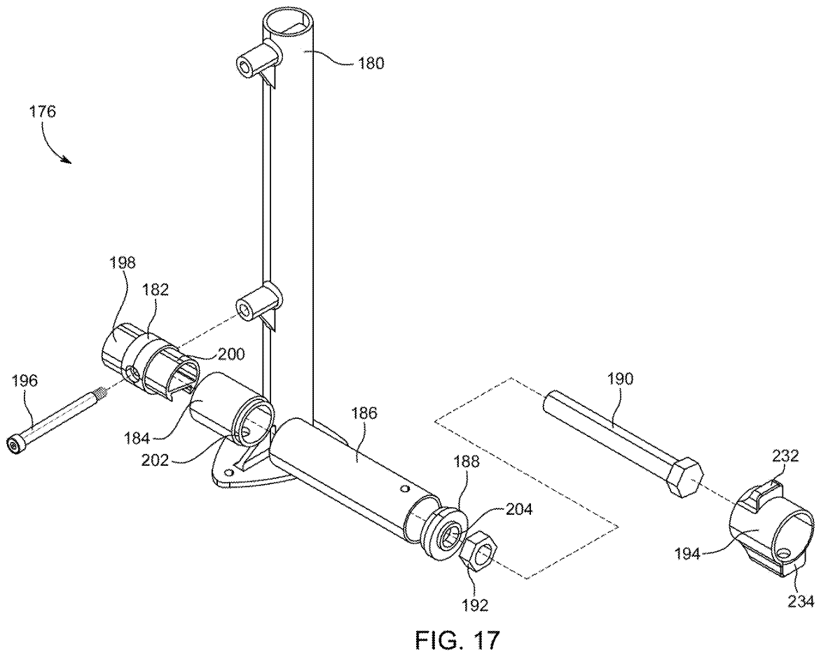

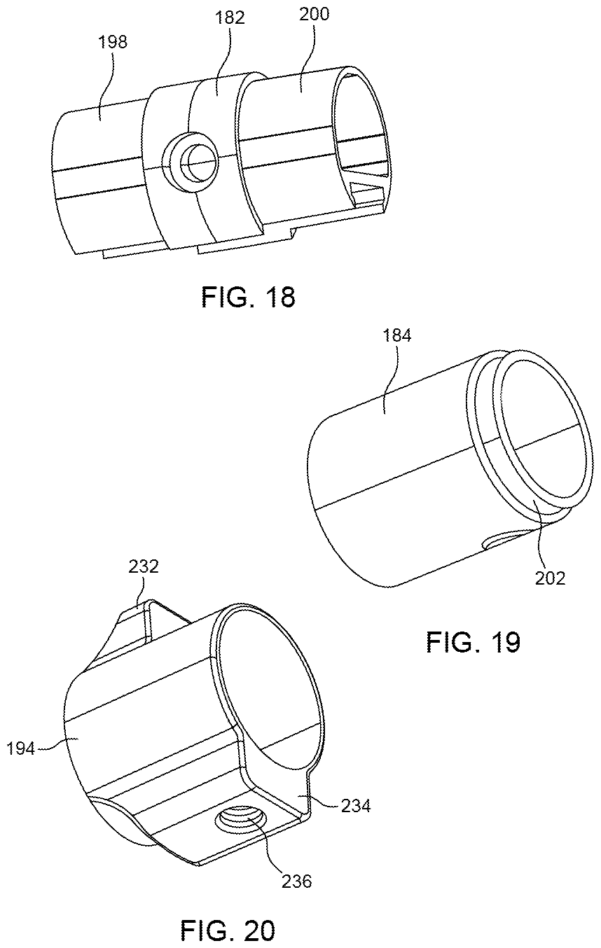

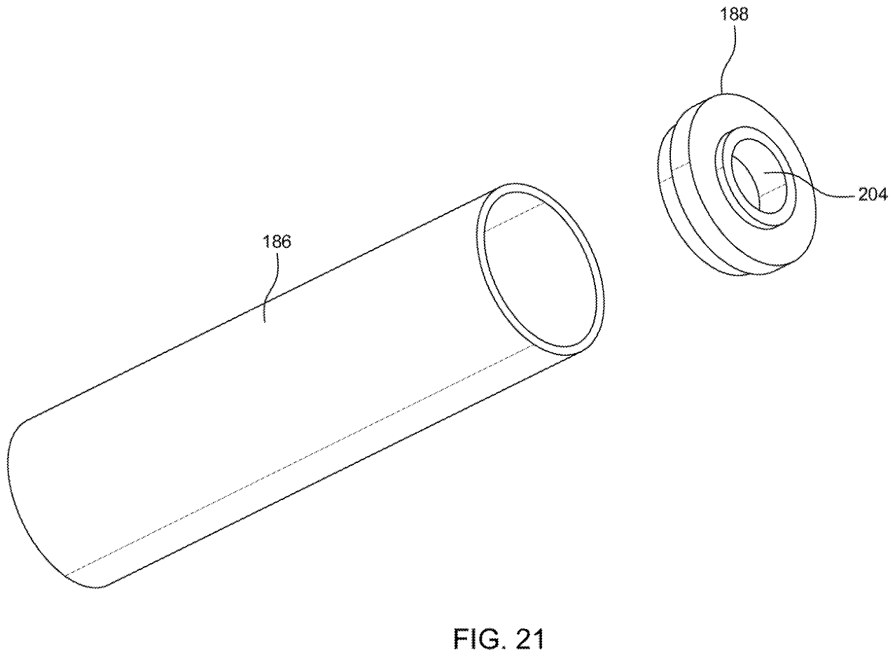

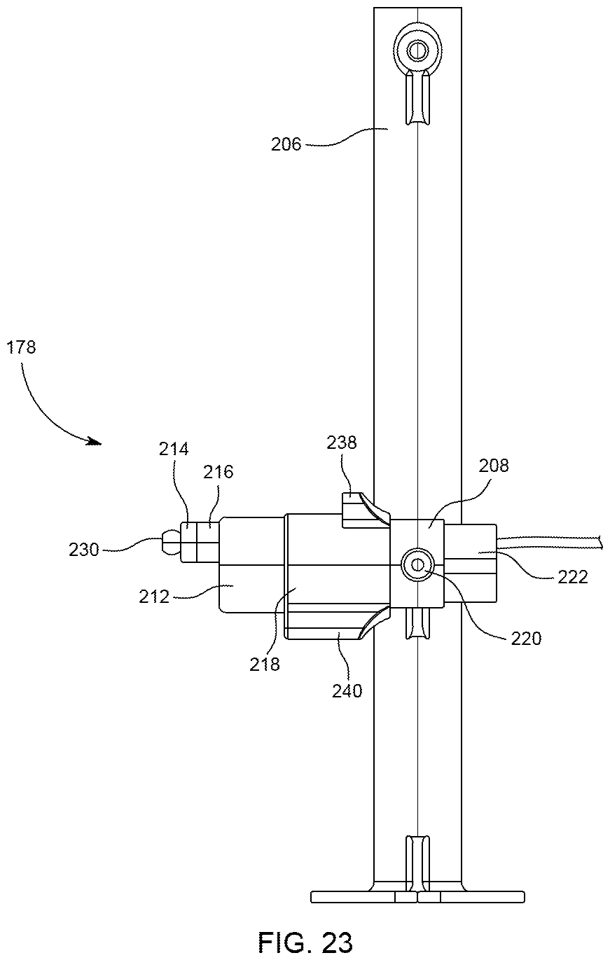

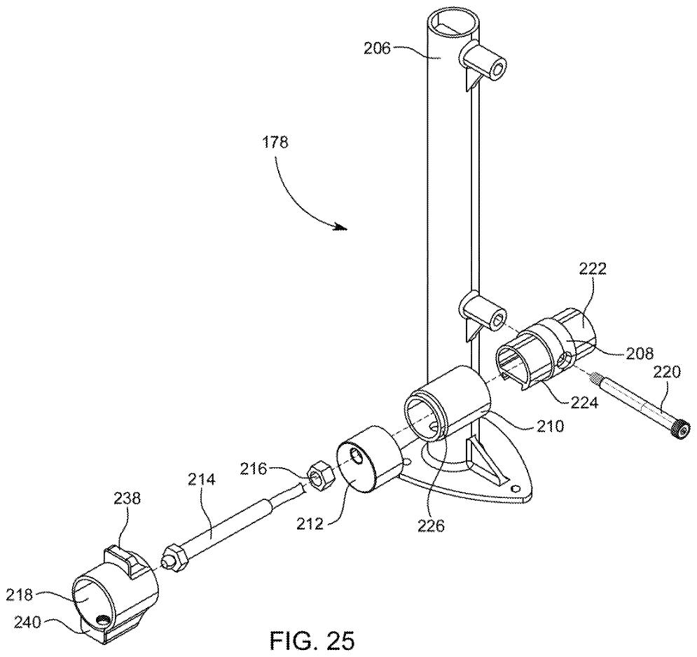

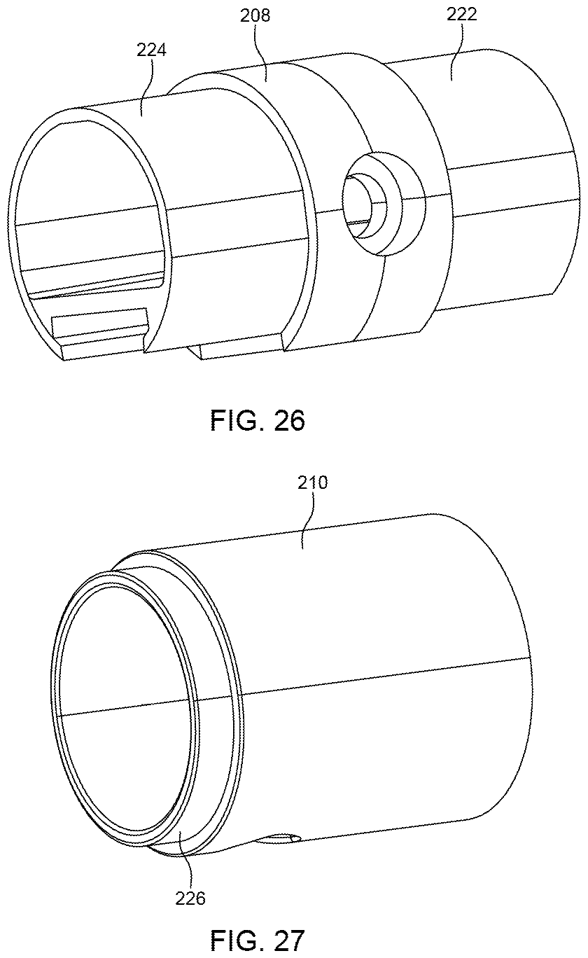

The apparatus, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of stair lift systems are hereinafter disclosed and described in detail with reference made to FIGS. 1-33.

As will be described in detail herein, this disclosure is directed to embodiments of stair lift systems with modular stair rail assemblies, modular post assemblies, and a cable tensioning system for convenient operation and safety that together are suitable for forming a stable and configurable system to assist a user in traversing pre-existing stairways and staircases in residential and commercial settings. The embodiments are arranged to facilitate efficient manufacturing, transporting, inventorying, sourcing, distributing, delivering, assembling, and installing such stair lift systems regardless of the arrangement or configuration of the pre-existing stairway or staircase. In particular, the modular stair rail assemblies disclosed herein (also referred to generally as “rail systems”) can include multiple subcomponents that are arranged to be interchangeably assembled to accommodate the spatial, dimensional, and physical arrangement and configuration of the large variety of pre-existing residential and commercial stairways and staircases. Such stair lift systems, and specifically, such modular rail assemblies and modular post assemblies, can be customized and assembled on-site during the installation process by a contractor, other such worker, or even a homeowner. Once the modular post assemblies are assembled, several can be secured to one side of the treads of the staircase from the bottom of the staircase to the top of the staircase. Then the modular rail assembly can be configured and assembled (as a pair of rail subassemblies) and secured to the modular post assemblies along one side of the staircase such that the modular rail assembly extends from the bottom of the staircase to the top of the staircase. A chair can be engaged with the rail assembly such that the chair can traverse the length of the rail assembly to move the chair and its occupant selectively and safely between the bottom and the top of the staircase. In certain embodiments, the rail system can be secured directly to the treads of a staircase without the need for posts. Embodiments of stair lift system described herein are suitable for staircases that include landings and turns along the staircase as well as straight staircases.

FIG. 1 schematically illustrates one embodiment of a modular rail assembly 10 installed and secured at one edge of a pre-existing staircase 5. The modular rail assembly 10 includes an upper rail subassembly 12 and a lower rail subassembly 14 supported by a series of modular post assemblies 16. It will be appreciated that the modular rail assembly 10 is customized to accommodate the angle of the staircase, the size of the lower, middle, and upper landings, and the 180 degree turn at the middle landing. FIG. 2 is an illustration of a prior art stair lift system. The stair lift system uses a dual rail arrangement equipped with a traction drive system, propelling the chair from a first lower floor in a home to a second, higher floor in the home. It will be appreciated that prior art lift chairs and drive systems, including traction drive systems, may be combined with the modular rail assemblies disclosed herein. Moreover, the modular rail assemblies may be adapted to accommodate various embodiments of commercially available lift chairs or lift chairs built specifically for use with the modular rail assembly.

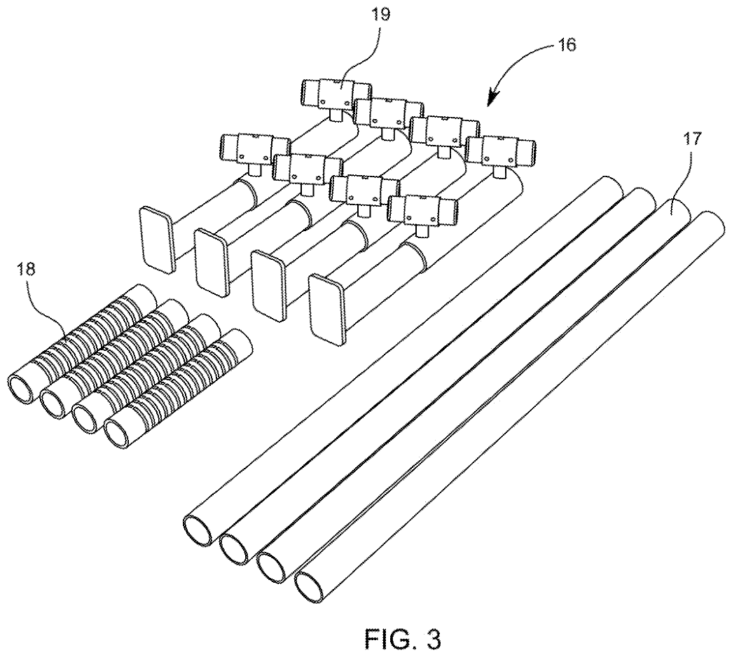

As shown in FIG. 1 and FIG. 3, the modular rail assembly (also referred to herein as a “rail assembly”) 10 may include a plurality of modular post assemblies 16, a plurality of straight rail segments or segments 17, and a plurality of corner rail segments or segments 18. The modular post assemblies 16 and rail segments 17 and 18 may be joined together to form the rail assembly 10 using connectors 19 coupled to the modular post assemblies 16. The corner rail segments 18 illustrated in FIG. 3 are designed to bend to accommodate the configuration of the customer's staircase, allowing an installer to dynamically customize the shape.

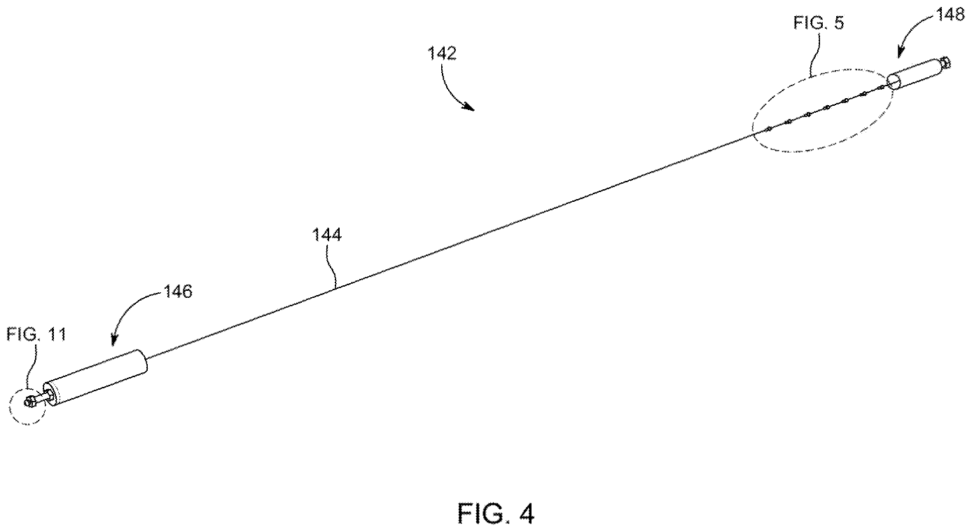

A number of embodiments of cable tensioning assemblies useful in securing components of modular rail assemblies are illustrated in FIGS. 4-31. FIGS. 4-13 illustrate an embodiment of an exemplary cable tensioning assembly 142 generally for use with modular rail assemblies. In one example, the cable tensioning assembly 142 can span the entire length of a modular rail assembly and can add structural stability and redundance to the modular rail assembly. In another embodiment, the cable tensioning assembly 142 can span a portion of the modular rail assembly, such as from the bottom of the stairway to a landing area a portion of the way up the stairway or from such a landing area to the top of the stairway. Such arrangements can prevent misalignments and deformation of components over time as well as safeguard against structural failure of the modular rail assembly. The cable tensioning assembly 142 is arranged such that it can be generally configured with the approximate overall length needed to secure multiple modular rail assembly components together and then manipulated to maintain a tension force that applies a desirable compressive force on the multiple modular applications to provide the appropriate structural support for the modular rail assembly.

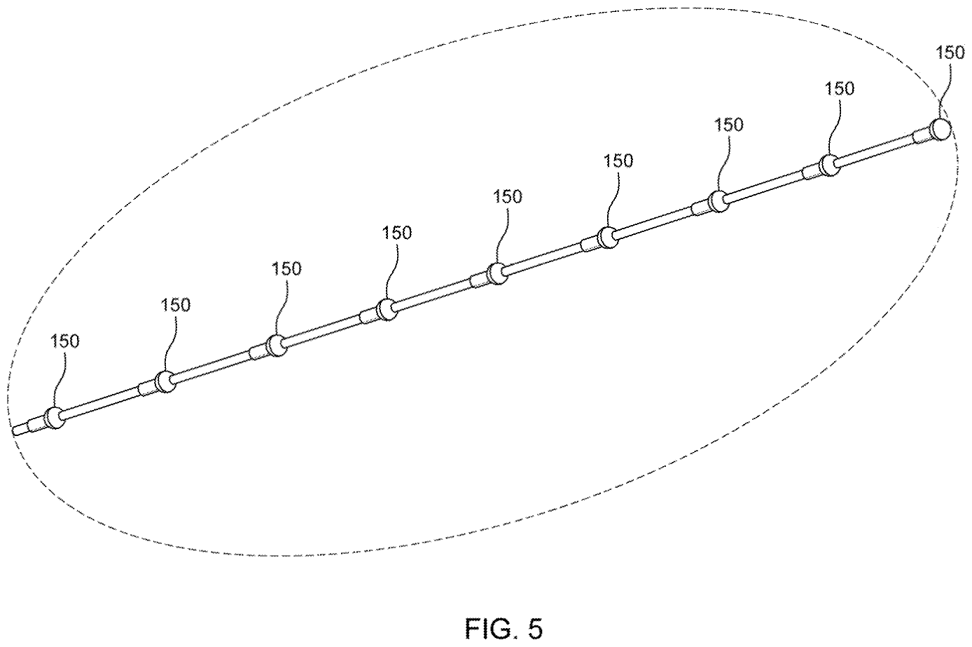

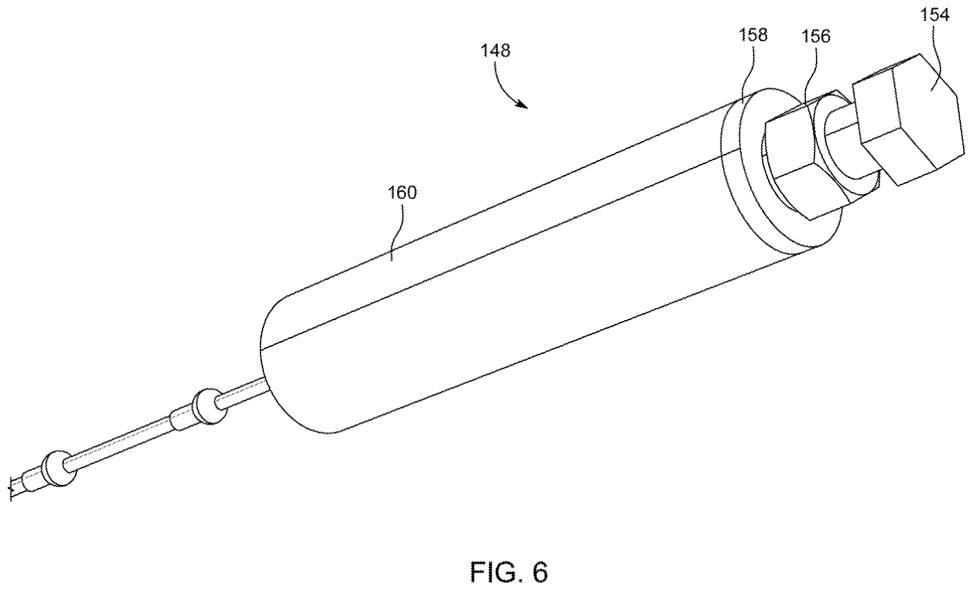

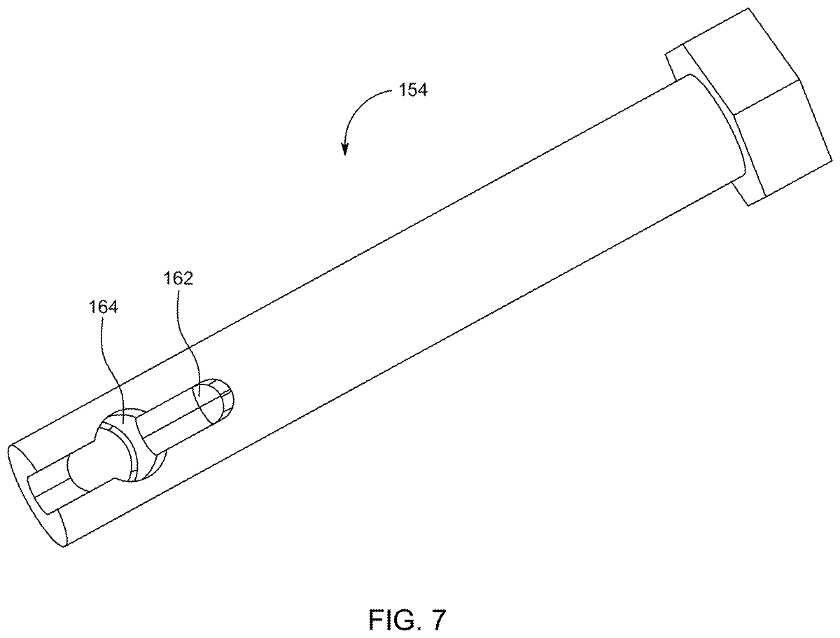

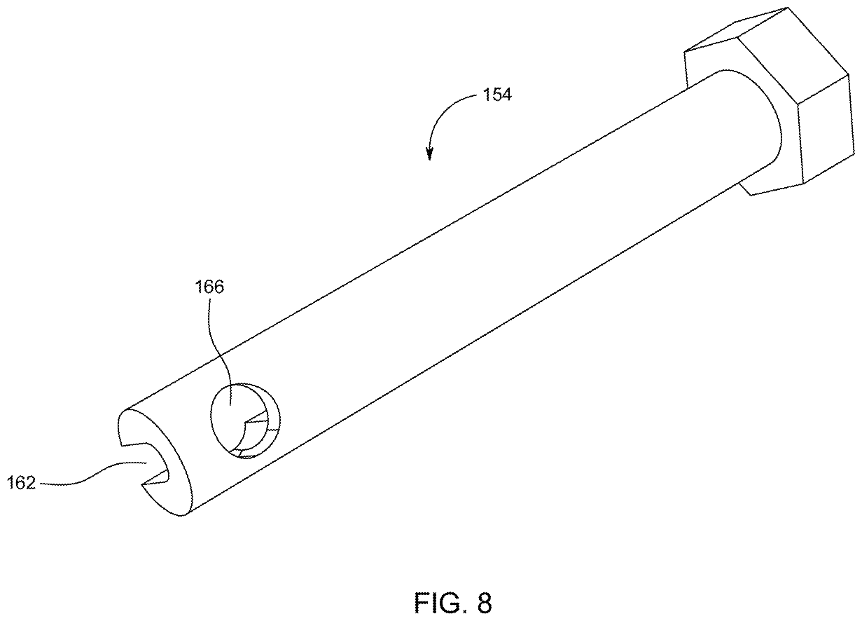

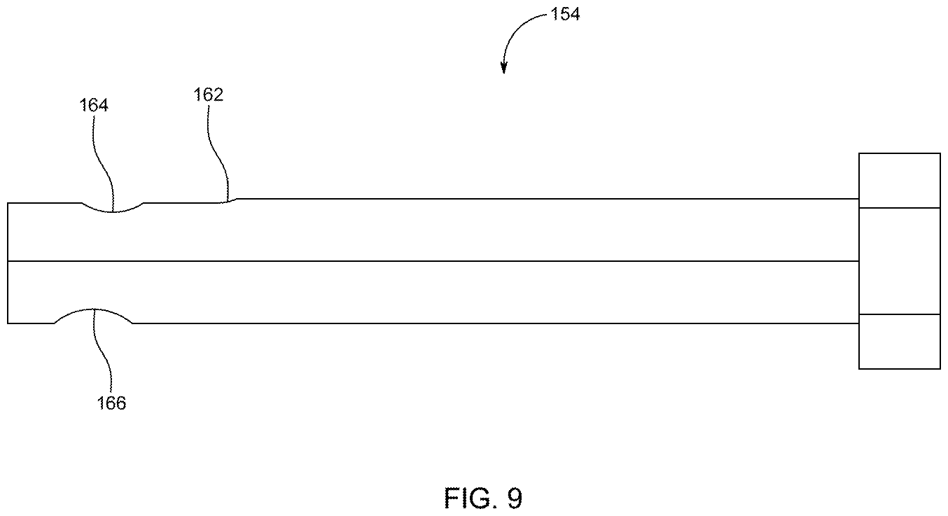

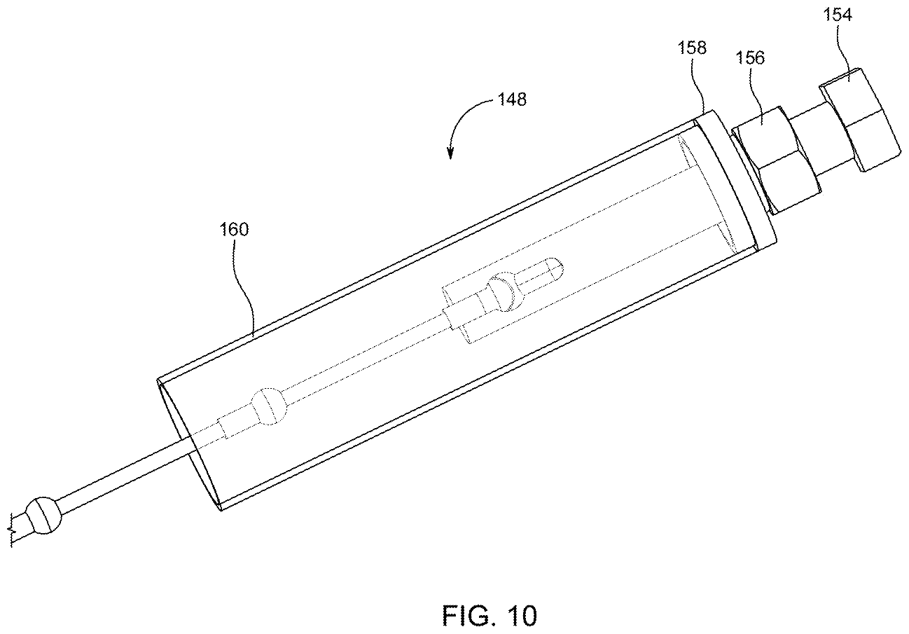

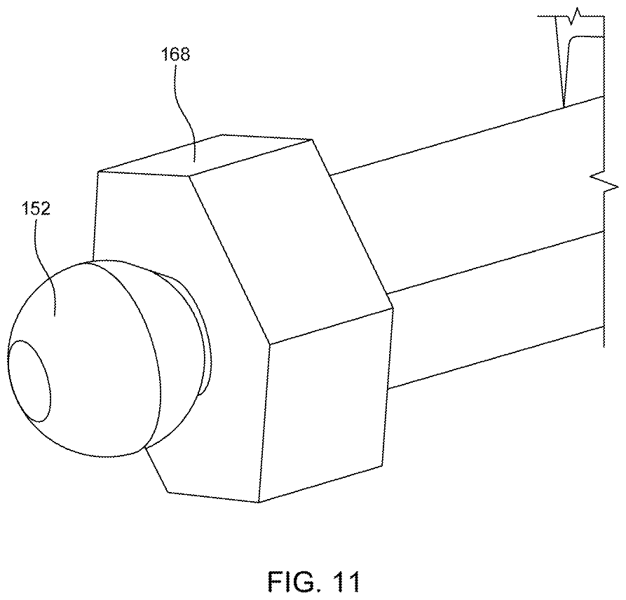

The cable tensioning assembly 142 includes a cable 144, an anchor assembly 146 on one end of the cable 144, and a tension assembly 148 on the opposite end of the cable 144. The cable 144 includes a series of ball shanks 150 (illustrated in FIG. 5) located proximate to the tension assembly 148. The cable 144 also includes a single ball shank 152 located at one end of the cable 144 (illustrated in FIG. 11) and located proximity to the anchor assembly 146. As illustrated in FIGS. 6-10, the tension assembly 148 includes a number of components including a tensioning bolt 154, a tensioning nut 156, a tensioning end flange 158, and a tensioning rail extension 160. In some embodiments, the tensioning end flange 158 is substantially flat and includes a thrust bearing between the tensioning end flange 158 and the tensioning nut 156 to reduce friction during tensioning. The tensioning bolt 154 is externally threaded (not illustrated) to accommodate the tensioning nut 156. As illustrated in FIGS. 7-9, the tensioning bolt 154 includes a slot 162 that can accommodate one of the ball shanks 150 of the cable 144. The tensioning bolt 154 further includes a first aperture 164 formed in the slot 162 and a second aperture 166 (illustrated in FIGS. 8 and 9) formed opposite the first aperture 164. The first aperture 164 is arranged such that a ball shank 150 can be inserted through the first aperture 164, into an upper portion of the slot 162, and slid downward to secure the ball shank 150 within the slot 162. The second aperture 166 is formed slightly off center from the first aperture 164 and positioned lower on the tensioning bolt 154 (illustrated in FIG. 9). Such an arrangement allows the ball shank 150 to partially move into the second aperture 166 as it is slid downward in the slot 162 to facilitate the slot 162 securing the ball shank 150. The positioning of the ball shank 150 within the slot 162 is illustrated in FIG. 10 (where the tensioning rail extension 160 is transparent to reveal the slot 162 and ball shank 150).

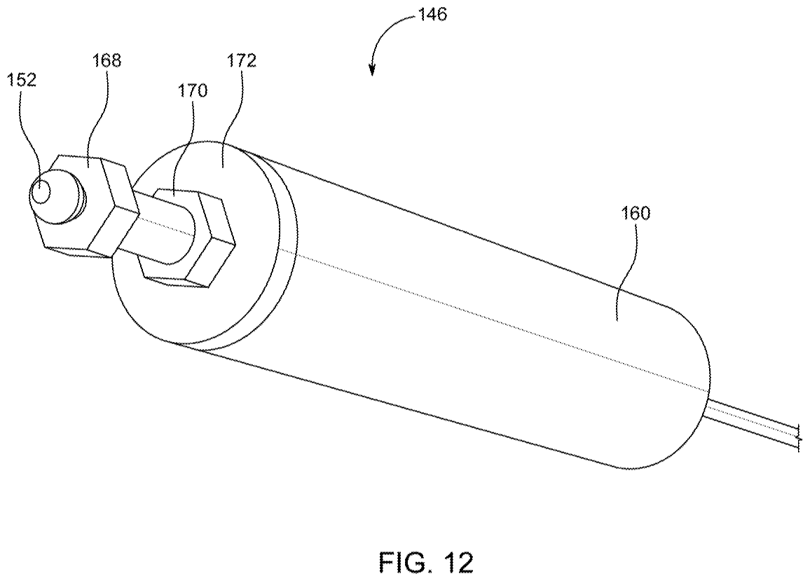

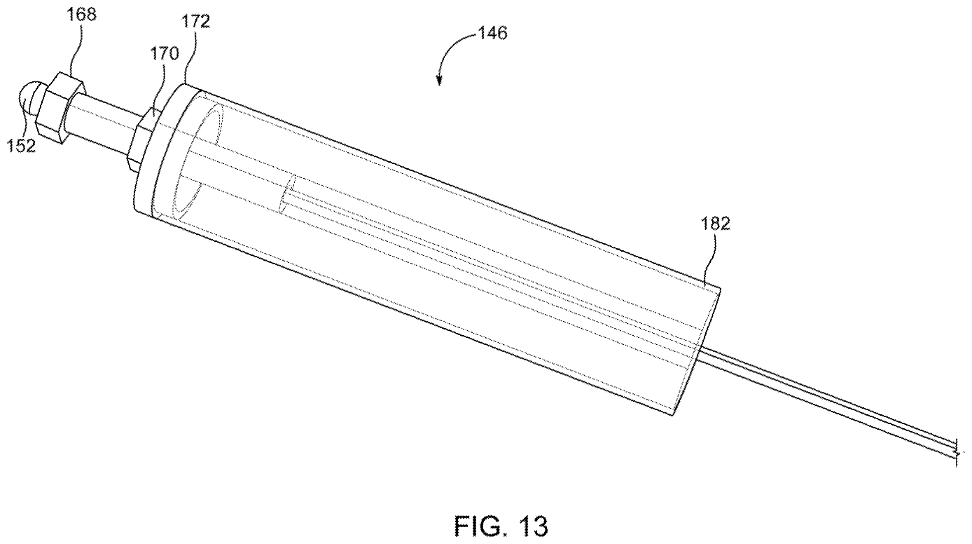

The anchor assembly 146 includes an anchor bolt 168, an anchor nut 170, an anchor end flange 172, and an anchor rail extension 174. The anchor bolt 168 is externally threaded to accommodate the anchor nut 170 and includes a hollow shaft that accommodates the cable 144. As illustrated in FIG. 12, the cable 144 is accommodated in the anchor bolt 168 such that the ball shank 152 is outside the head of the anchor bolt 168 and the cable 144 passes through the hollow shaft of the anchor bolt 168 (the anchor rail extension 174 is transparent in FIG. 13 to reveal the positioning of the cable 144 within the anchor bolt 168). The anchor assembly 146 is assembled onto the cable 144 prior to the ball shanks 150, 152 being secured to the cable 144. As will be appreciated, because of the placement of the ball shanks 150, 152, the anchor assembly 146 cannot be mounted onto the cable 144 after the ball shanks 150, 152 are secured to the cable 144.

An exemplary process for assembling the cable tensioning assembly 142 is described as follows. In one example, an installer measures the approximate overall length of the cable tensioning assembly 142 required for securing the desired multiple modular rail assembly components together and calculates the appropriate amount of additional length needed to accommodate the anchor assembly 146 and the tension assembly 148. The installer then trims the cable 144 at one of the series of ball shanks 150 that results in a length of cable 144 that exceeds the required overall length calculated by the installer. In another example, various standard lengths of the cable 144 are predetermined and provided based on common features of residential home staircases such as ceiling height, slope of stairs, number and length of landings, whether the installation is on the lefthand or righthand sided of a stair case with landings (i.e., whether it is an “inside” installation or an “outside” installation with reference to the turns of the staircase), whether the rail system will end at the top and/or bottom of the staircase or will be extended past the top and/or bottom of the staircase, and other such considerations. In this example, the installer will select the predetermined length that best suits the specific installation. In another example, shorter lengths of cable can be provided with ball shanks positioned along the length of cable. Additional components can be provided such as adapters that are used to couple a number of such shorter cable lengths together to customize the overall length of the cable to the specific installation.

As will be appreciated, the ball shanks 150 are positioned equidistant from each other, in this example, approximately 3 inches apart, such that the cable 144 can be trimmed to multiple lengths leaving a ball shank 150, 152 on each end of the cable 144 to accommodate a number of installations. It will be understood that the 3 inch distance is exemplary only and any number of different distances can be used based on practical considerations or preference. In some embodiments, the distance between subsequent ball shanks 150 is associated with a dimension of the anchoring bolt 168. For example, the distance between subsequent ball shanks 150 can be associated with the length of the anchoring bolt 168. Specifically, the distance between subsequent ball shanks 150 may be equal to or less than the travel distance of the anchoring nut 170 along the anchoring bolt 168. Having the distance between ball shanks 150 being associated with the anchoring bolt 168 allows for the anchoring bolt 168 to remove slack from the cable 144 prior to tensioning regardless of how many ball shanks 150 are removed.

Once the appropriate length of cable 144 is selected, the cable 144 is generally trimmed (leaving some slack to adjustments), the tensioning bolt 154 is arranged so that the head of the tensioning bolt 154 is positioned next to the tensioning nut 156, and the anchor bolt 168 is arranged so that the head of the anchor bolt 168 is positioned next to the anchor nut 170. As will be appreciated, such positioning provides for the maximum travel outward of both the tensioning bolt 154 and anchor bolt 168 during the tensioning process. The assembly typically begins with assembling components in order from the bottom of the staircase to the top of the staircase and feeding the end of the cable 144 with the multiple ball shanks 150 through each component in order. The first components assembled are the anchor assembly 146 components, which will be positioned at the bottom of the staircase, with ball shank 152 at the opposite end of the cable 144 positioned adjacent to the head of the anchor bolt 168. The cable 144 is fed through each additional component of the rail system and, as applicable, each of those components are connected to each other and/or secured to a post. The components of the tensioning assembly 148 are the last to be assembled. The cable 144 on its free end at the top of the staircase is trimmed at the ball shank 150 that best meets the overall length of the rail system. The last ball shank 150 at the cut end of the cable 144 is placed into the slot 162 of the tensioning bolt 154 and secured within the slot 162. The cable tensioning assembly 142 is then tensioned. In one example, the anchor bolt 168 is rotated in a counterclockwise direction to move the head of the anchor bolt 168 away from the anchor nut 170 until all excess slack is removed from the cable 144. If required, the tensioning bolt 154 is rotated in a counterclockwise direction to move the head of the tensioning bolt 154 away from the tensioning nut 156 until the desired tension is applied to the cable 144. During such a process, during the rotation of the anchor bolt 168 and/or the tensioning bolt 154, the cable 144 is preferably not spun or twisted. In another example, the anchor nut 170 is rotated in a clockwise direction to move the head of the anchor bolt 168 away from the anchor nut 170 until all excess slack is removed from the cable 144. If required, the tensioning nut 156 is rotated in a clockwise direction to move the head of the tensioning bolt 154 away from the tensioning nut 156 until the desired tension is applied to the cable 144. During such a process, during the rotation of the anchor nut 170 and/or the tensioning nut 156, the cable 144 will not be spun or twisted. It will be appreciated that the anchor bolt 168 and anchor nut 170 can include course threads and the tensioning bolt 154 and tensioning nut 156 can include comparatively fine threads. This arrangement facilitates the anchor bolt 168 and anchor nut 170 adjustments providing for gross adjustment of the tension of the cable 144 and the tensioning bolt 154 and tensioning nut 156 providing precise or fine tuning of the tension on the cable 144.

General instructions can be provided to installers for the use of the cable tensioning assembly 142 during installation. Such instructions can prevent damage to components due to over tightening and ensure that the actual forces applied are effective in providing structural support to the modular rail assemblies. For example, installation instructions can include a preset torque value. A torque measuring device such as a torque wrench or other similar device can then be used during installation to measure the torque applied to the tensioning bolt 154 or tensioning nut 156 and/or the anchor bolt 168 or anchor nut 170 during installation. The installer will then apply the torque to the tensioning bolt 154 or tensioning nut 156 and/or the anchor bolt 168 or anchoring nut 170 in accordance with the preset torque value of the installation instructions.

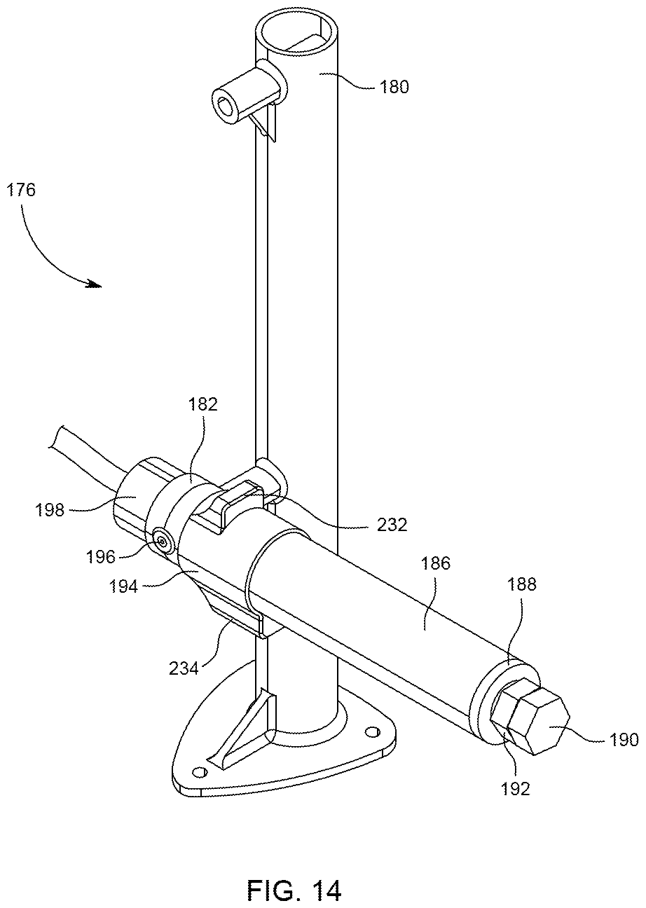

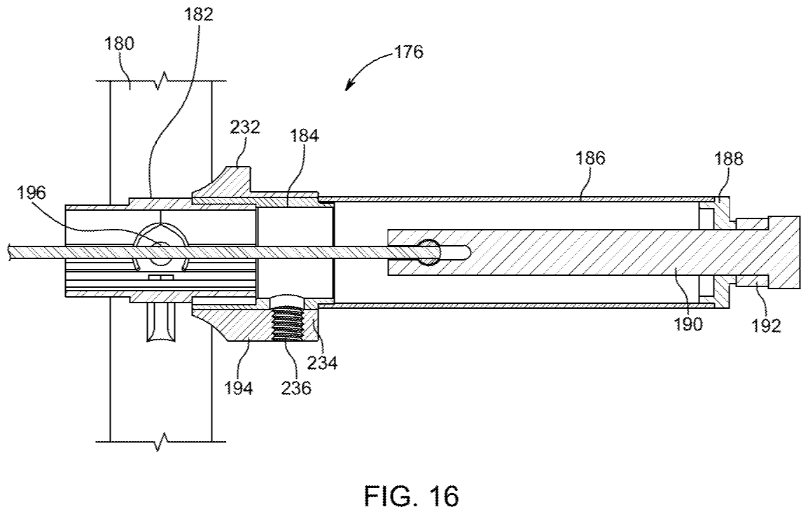

FIGS. 14-33 illustrate other embodiments of subassemblies and components of a cable tensioning assembly. In a first embodiment, a cable tensioning assembly includes a tensioning assembly 176 and an anchoring assembly 178. The tensioning assembly 176 and the anchoring assembly 178 are located at opposite ends of a stair lift system and facilitate the positioning and tensioning of a cable to support the structural integrity and alignment of a modular rail assembly. The tensioning assembly 176 is illustrated in FIGS. 14-21. The tensioning assembly 176 can be coupled to a terminal post 180 positioned at one end of the stair lift system by a rail connector 182. The tensioning assembly 176 incudes a tensioning end stop adapter 184, a tensioning rail extension 186, a tensioning bolt cap 188, a tensioning bolt 190, a tensioning nut 192, and a tensioning end stop 194. The tensioning end stop adapter 184, tensioning rail extension 186, and tensioning bolt cap 188 are cylindrical components that generally conform to the shape of a modular rail segments and form an extension of the modular rail assembly. The rail connector 182 is arranged to connect on a first end to a rail segments of a modular rail assembly and connect on a second and opposite end to a tensioning assembly 176. The rail connector 182 is further arranged to be secured to the terminal post 190 by a bolt 196, thus securing the rail segment and the tensioning assembly 176 to the terminal post 190. The rail connector 182 can be attached to the terminal post 180 in a manner that allows for rotational adjustment of the rail connector 182 relative to the terminal post 180 so that components can be aligned during installation based on the particular circumstances of the staircase. The rail connector 182 includes a pair of recessed cylindrical surfaces 198, 200, one on each end of the rail connector 182. These recessed cylindrical surfaces 198, 200 are arranged to accommodate an inner diameter of a rail segment (not illustrated) and an inner diameter of the tensioning end stop adapter 184 (illustrated in cross-sectional view FIG. 16). The tensioning end stop adapter 184 also includes a recessed cylindrical surface 202, which is arranged to accommodate an inner diameter of the tensioning rail extension 186 (illustrated in cross-sectional view FIG. 16). The tensioning bolt cap 188 is arranged to be inserted into the opposite end of the tensioning rail extension 186. The tensioning bolt cap 188 includes a centrally located aperture 204, which accommodates the tensioning bolt 190 passing through the aperture 204. The tensioning nut 192 is positioned onto the tensioning bolt 190 to generally complete the tensioning assembly 176 (the addition of the tensioning end stop 194 will be further discussed herein). As illustrated in FIG. 16, once assembled, the components of the tensioning assembly 176 form a solid cylindrical assembly with a central passage. This central passage is colinear with a passage passing through the modular rail assembly. It will be appreciated that such a passage that can accommodate a tensioning cable, one or more power cables, and wiring that can span the stair lift system.

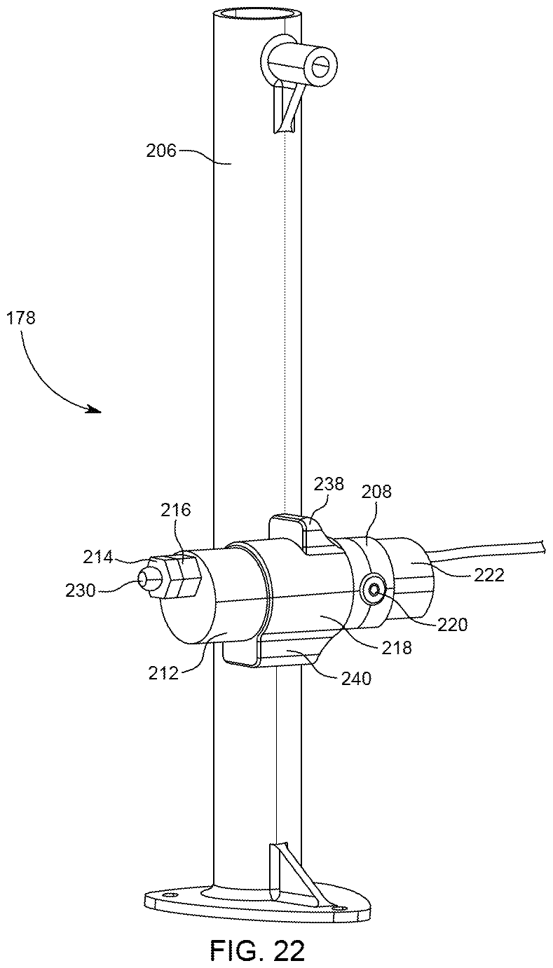

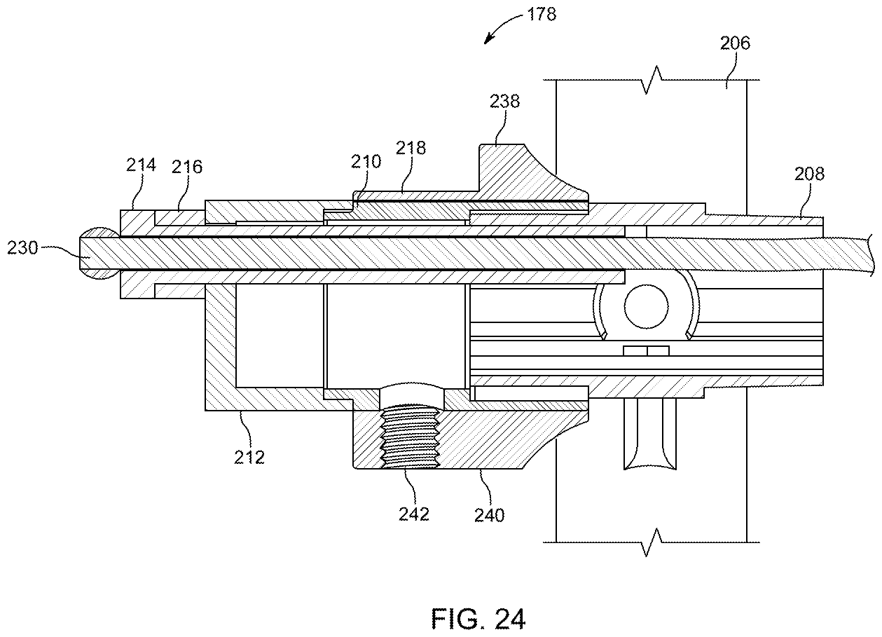

An embodiment of an anchoring assembly 178 is illustrated in FIGS. 22-29. The anchoring assembly 178 can be coupled to a terminal post 206 positioned at an opposite end of the stair lift system from the tensioning assembly 176 by a rail connector 208. The anchoring assembly 178 includes an anchoring end stop adapter 210, an anchoring bolt cap 212, an anchoring bolt 214, an anchoring nut 216, and an anchoring end stop 218. The anchoring end stop adapter 210, anchoring bolt cap 212 and anchoring end stop 218 are all generally cylindrical components that generally conform to the shape of a modular rail segments and form an extension of the modular rail assembly. The rail connector 208 is arranged to connect on a first end to a rail segments of a modular rail assembly and connect on a second and opposite end to an anchoring assembly 178. The rail connector 208 is further arranged to be secured to the terminal post 206 by a bolt 220, thus securing the rail segment and the anchoring assembly 178 to the terminal post 206. The rail connector 208 can be attached to the terminal post 206 in a manner that allows for rotational adjustment of the rail connector 208 relative to the terminal post 206 so that components can be aligned during installation based on the particular circumstances of the staircase. The rail connector 208 includes a pair of recessed cylindrical surfaces 222, 224, one on each end of the rail connector 208. These recessed cylindrical surfaces 222, 224 are arranged to accommodate an inner diameter of a rail segment (not illustrated) and an inner diameter of the anchoring end stop adapter 210 (illustrated in cross-sectional view FIG. 24). The anchoring end stop adapter 210 also includes a recessed cylindrical surface 226, which is arranged to accommodate an inner diameter of the anchoring bolt cap 212 (illustrated in cross-sectional view FIG. 24). The anchoring bolt cap 212 includes an offset aperture 228, which accommodates the anchoring bolt 210 passing through the offset aperture 228. The anchoring nut 216 is positioned onto the anchoring bolt 214 and the anchoring bolt 214 is passed through the offset aperture 228 to generally complete the anchoring assembly 178 (the addition of the anchoring end stop 218 will be further discussed herein). As illustrated, the aperture 228 is offset such that it is not located in the center of the anchoring bolt cap 212 but is set off to one side near the perimeter of the anchoring bolt cap 212. As illustrated in FIG. 24, once assembled, the components of the anchoring assembly 178 form a solid cylindrical assembly with a central passage that can accommodate a cable and, this central passage is colinear with the passage passing through the modular rail assembly.

During installation of a stair lift system, the tensioning assembly 176 and anchoring assembly 178 are assembled as follows. Starting with the anchoring assembly 178, the rail connector 208 is engaged with the last rail segment of the modular rail assembly by sliding the end of the rail segment over the recessed surface 222 of the rail connector 208. The rail connector 208 is then secured to the terminal post 206 using the bolt 220. The bolt 220 is not fully tightened, allowing for some rotational motion of the rail connector 208 relative to the terminal post 206. The anchoring end stop adaptor 210 is then slid over the opposite recessed surface 224 of the rail connector 208. It will be understood that the rail segment and anchoring end stop adaptor 210 can be secured to the rail connector 208 by a number of mechanism including a set screw, adhesives, friction fits, and the like. The anchoring bolt cap 212 is then slid over the recessed surface 226 of the anchoring end stop adapter 210. Similar to prior description, it will be understood that the anchoring bolt cap 212 can be secured to the anchoring end stop adapter 210 by a number of mechanism including a set screw, adhesives, friction fits, and the like. The anchoring nut 216 is threaded onto the anchoring bolt 214. One end of the cable (which is passed through the modular rail segments such that one of the cable is positioned near the end of the anchoring assembly 146) is then secured to the anchoring bolt 214 as previously described. For example, the anchoring bolt 214 can have a hollow shaft and an aperture in its head such that the cable is secured to the anchoring bolt 214 through a ball shank 230 positioned at the end of the cable (as illustrated in FIGS. 22-25). The anchoring bolt 214 is then inserted into the aperture 228 in the anchoring bolt cap 212. As will be subsequently described, the offset nature of the aperture 228 can facilitate both the installation of the stair lift system and accommodate additional components positioned within the passage through the modular rail assembly.

Once the anchoring assembly 178 is assembled as described, the cable end with the series of ball shanks is fed through all other components of the rail system and those components are assembled. Then the tensioning assembly 176 is assembled as follows. The rail connector 182 is engaged with the last rail segment of the modular rail assembly by sliding the end of the rail segment over the recessed surface 198 of the rail connector 182. The rail connector 182 is then secured to the terminal post 180 using the bolt 196. The bolt 196 is not fully tightened, allowing for some rotational motion of the rail connector 182 relative to the terminal post 180. The tensioning end stop adaptor 184 is then slid over the opposite recessed surface 200 of the rail connector 182. It will be understood that the rail segment and tensioning end stop adaptor 184 can be secured to the rail connector 182 by a number of mechanism including a set screw, adhesives, friction fits, and the like. The tensioning rail extension 186 is then slid over the recessed surface 202 of the tensioning end stop adapter 184 and the tensioning bolt cap 188 is inserted into the free end of the tensioning rail extension 186. It will be understood that the tensioning rail extension 186 and the tensioning bolt cap 188 can be secured by a number of mechanism including a set screw, adhesives, friction fits, and the like. The tensioning nut 192 is threaded onto the tensioning bolt 190. The free end of the cable is then secured to the tensioning bolt 190 as previously described. For example, the tensioning bolt 190 can include a slot that secures a ball shank of the end of the cable. The tensioning bolt 190 is then inserted into the aperture 204 in the tensioning bolt cap 188. As previously described, the installer can use the tensioning bolt 190 and tensioning nut 192 and the anchoring bolt 214 and anchoring nut 216 to apply an appropriate force on the cable to secure and align the modular rail assembly. Once the force is applied and all components are aligned, the bolts 196, 220 for the two rail connectors 182, 208 can be fully tightened to secure all components. In some embodiments, the bolts 196, 220 can be tightened prior to tensioning.

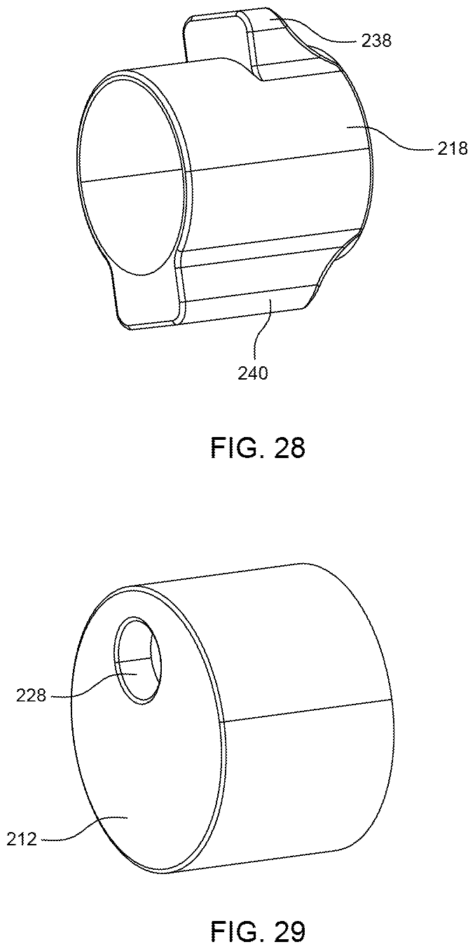

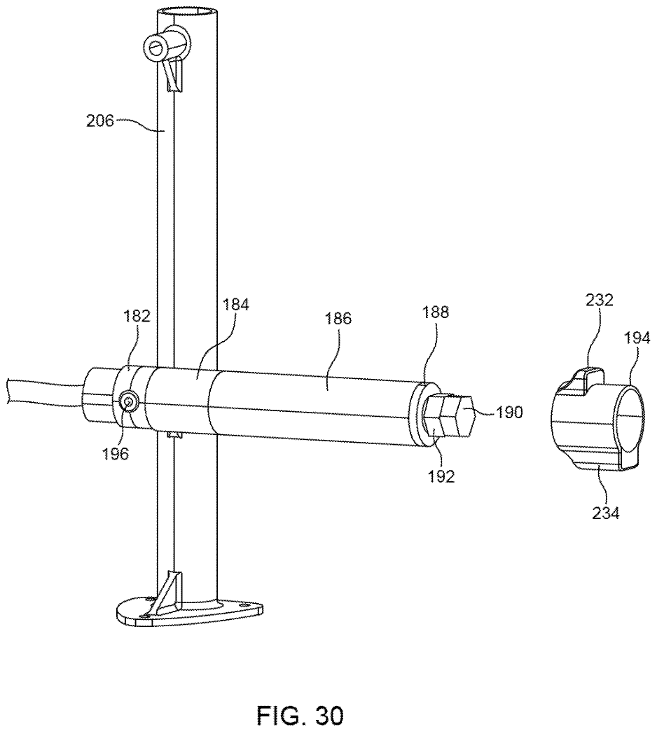

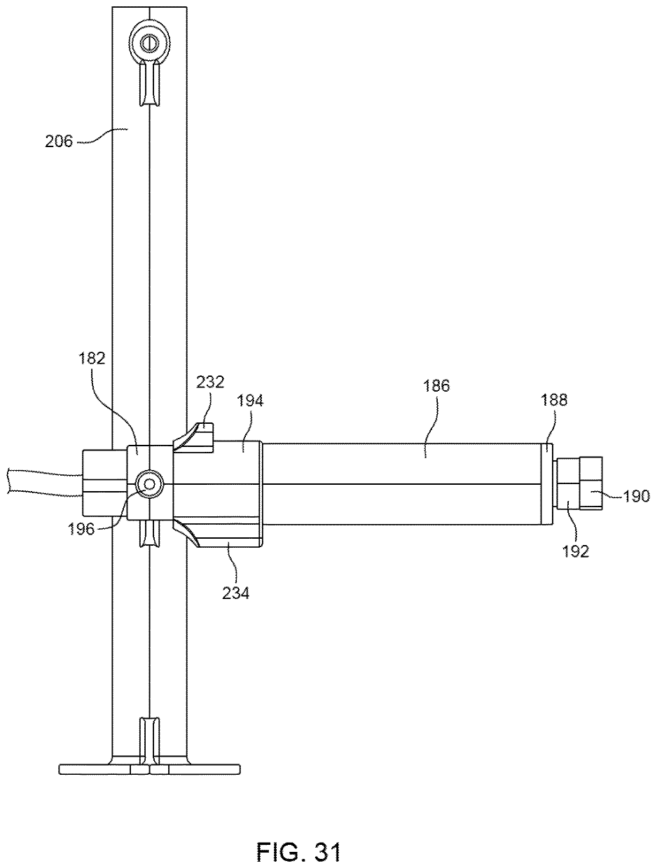

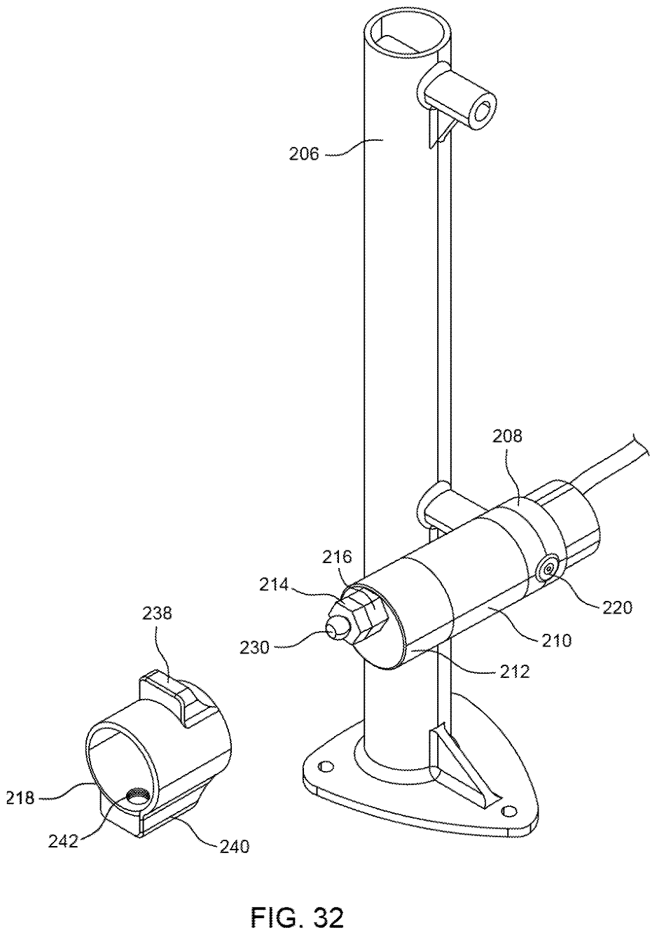

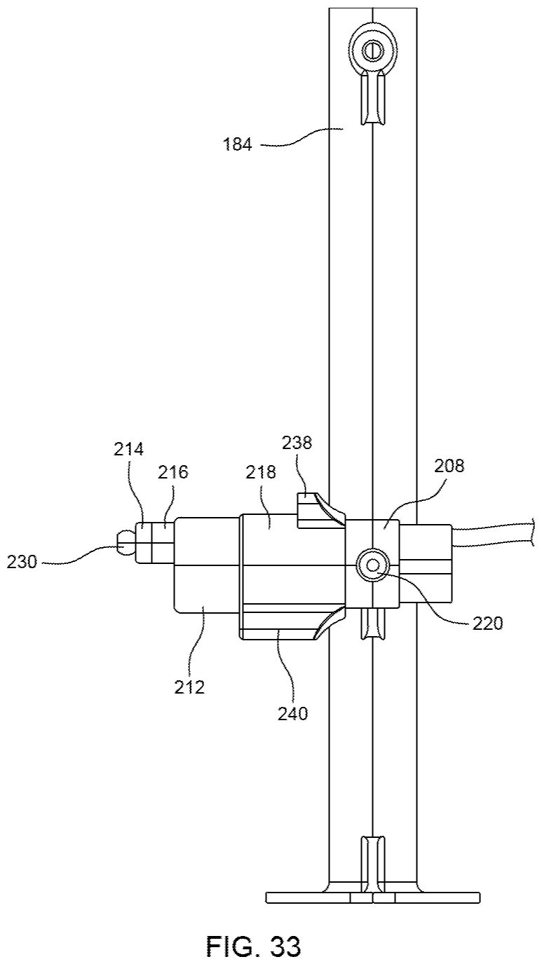

Once the anchoring assembly 178 and tensioning assembly 176 are installed as described above, the cable is properly tensioned, all fasteners are tightened, and all components are checked for proper installation. The chair assembly is then ready to be mounted on the rail system to complete the stair lift system. The chair assembly can be mounted from either the anchoring assembly 178 side or the tensioning assembly 176 side. As is illustrated in FIGS. 30 and 32, the tensioning end stop 194 and the anchoring end stop 218 are left unassembled (depending on what side the chair assembly is to be mounted) until the chair assembly is mounted on the rail system. Because the outer diameter of the anchoring assembly 178 and tensioning assembly 176 are arranged to match the outer diameter of the modular rail system, the chair assembly can be mounted onto either the anchoring assembly 178 or tensioning assembly 176 and driven over the rail connector 182, 208 onto modular rail system. Once the chair assembly is positioned on the modular rail system, the tensioning end stop 194 can be slid over the tensioning assembly 176 and/or the anchoring end stop 218 can be slid over the anchoring assembly 178 to complete the assembly. As illustrated in FIG. 20, the tensioning end stop 194 includes a first wedge extension 232, a second wedge extensions 234 and a threaded aperture 236, and as illustrated in FIG. 28, the anchoring end stop 218 includes a first wedge extensions 238, a second wedge extension 240, and a threaded aperture 242 (as shown in FIG. 32). Once the chair assembly is mounted onto the modular rail assembly, the tensioning end stop 194 is slid into position (as illustrated in FIG. 30) and secured in position with a set screw positioned in the aperture 236, and the anchoring end stop 218 is slid into position (as illustrated in FIG. 32) and secured in position with a set screw positioned in the threaded aperture 242. Once the tensioning end stop 194 and anchoring end stop 218 are positioned as illustrated in FIGS. 31 and 33, the wedge extensions 232, 234, 238, 240 are positioned to function as mechanical stops to prevent the chair assembly from moving past the tensioning end stop 194 or the anchoring end stop 218. Such an arrangement provides an additional layer of safety and security during operation of the stair lift system.

In addition to the cable passing through the passage formed through the modular rail assembly, other components can also pass through the passage. For example, wiring and power cables can be positioned within the passage through the modular rail assembly. As is described herein, there are embodiments where several sensors and charging devises are positioned along a stair lift system. Each sensor and charging device can require power and/or wiring.

Having the aperture 228 in the anchoring bolt cap 212 offset from center provides more flexibility for the installation of the rail system, particularly at the bottom of a staircase. As will be appreciated, there is limited room at the bottom of a staircase due to the rail system being positioned at a downward angle and the floor positioned just after the last step. With the offset aperture 228 being located near the top of the anchoring bolt cap 212, it provides the maximum room for using the anchoring assembly 178 to take slack out of the cable tensioning assembly 142. It will also be appreciated that prior to tensioning the cable, it is advantageous to have the anchoring bolt 214 positioned as far into the anchoring bolt cap 212 as possible, this provides the anchoring bolt 214 with the maximum unobstructed travel during the tensioning process.

The methods of assembly above describe an installation where the anchoring assembly 178 is assembled first followed by the tensioning assembly 176. However, it will be understood that in certain embodiments, the installation method can include assembling the tensioning assembly 176 first followed by assembling the anchoring assembly 178. Such decisions can be made by installers based on the arrangement of the staircase and other specific circumstances and factors of the installation location.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. A cable tensioning system, comprising:
an adjustable cable having a first end and a second end, and a plurality of coupling point defined thereon, the adjustable cable being configured to extend through a plurality of assembled components arranged in series along an axis;
an adjustment system including:
an anchor assembly coupled to the first end of the adjustable cable; and
a tension assembly coupled to one coupling point of the plurality of coupling point,
the adjustment system configured to be adjusted to adjust a tension force in the adjustable cable so as to draw the plurality of assembled components together and apply a resulting compressive force thereon sufficient to impart a structural rigidity to the assembled components.

2. The cable tensioning system of claim 1, wherein the plurality of assembled components is a plurality of modular rail segments of a stair lift that assemble to form a stair lift rail configured to support a stair lift.

3. The cable tensioning system of claim 1, wherein the first end of the adjustable cable include a ball shank affixed thereto, the anchor assembly engaging the ball shank to couple the first end of the adjustable cable to the anchor assembly.

4. The cable tensioning system of claim 1, wherein the anchor assembly includes:
an anchor bolt having an externally threaded shaft and configured to engage the first end of the adjustable cable; and
a tensioning nut threaded on the anchor bolt, the nut configured to be threadably movable along the anchor bolt to adjust a slack from the adjustable cable.

5. The cable tensioning system of claim 1, wherein the second end of the adjustable cable includes a series of ball shanks affixed to the adjustable cable at each coupling point of the plurality of coupling points and spaced apart at predetermined intervals along a portion of the adjustable cable proximate to the tension assembly.

6. The cable tensioning system of claim 5, wherein the tension assembly includes:
a tensioning bolt having an externally threaded shaft, the tensioning bolt including a slot configured to receive one of the series of ball shanks at the second end of the adjustable cable to secure the second end of the adjustable cable to the tension assembly at a selected cable length; and
a nut threaded onto the tensioning bolt, the nut configured to be adjusted to adjust a tension in the adjustable cable.

7. The cable tensioning system of claim 6, wherein the adjustable cable is trimmable adjacent to each ball shank of the series of ball shanks so that each ball shank of the series of ball shanks is configured to engage the slot.

8. The cable tensioning system of claim 5, wherein a distance between each ball shank of the series of ball shanks is constant.

9. The cable tensioning system of claim 1, wherein the first end of the adjustable cable includes a ball shank, and an anchor bolt of the anchor assembly includes a hollow shaft through which the adjustable cable passes such that the ball shank at the first end of the adjustable cable secures the adjustable cable to the anchor assembly.

10. The cable tensioning system of claim 9, wherein the ball shank is configured to be positioned outside of a head of the anchor bolt to secure the adjustable cable to the anchor assembly.

11. The cable tensioning system of claim 1, wherein the anchor assembly engages a first end of the assembled components and the tension assembly engages a second end of the assembled components, wherein the compressive force is caused by the anchor assembly and the tension assembly being pulled together.

12. The cable tensioning system of claim 1, wherein the tensioning assembly provides fine adjustment in the tensioning force and the anchor assembly provides gross adjustment in the tensioning force.

13. The cable tensioning system of claim 12, wherein the tensioning assembly includes a tensioning bolt with fine threads and the anchor assembly includes an anchor bolt with coarse threads relative to the fine threads.

14. A method of assembling a modular rail by an internal cable, comprising:
providing an adjustable cable, the adjustable cable including an anchor assembly disposed at a first end of the adjustable cable and a series of ball shanks spaced at predetermined intervals along a portion of the adjustable cable at an opposing second end of the adjustable cable, the ball shanks being a plurality of coupling points;
inserting the adjustable cable within an internal cavity of a modular rail made of a plurality of rail segments arranged in series, such that the anchoring assembly engages a first end of the modular rail;
coupling a tensioning assembly to a last ball shank of the series of ball shanks, such that the tensioning assembly engages a second end of the modular rail;
adjusting the anchor assembly to remove slack from the adjustable cable and draw the plurality of rail segments tight to each other in series to provide structural rigidity to the modular rail; and
adjusting the tensioning assembly to increase a tension of the adjustable cable and to increase a compression on the modular rail to impart structural rigidity in the modular rail.

15. The method of claim 14, further comprising:
trimming, based on a length of the modular rail, a portion of the adjustable cable including a subset of the series of ball shanks.

16. The method of claim 14, further comprising:
inserting the adjustable cable through a hollow shaft of an anchor bolt of the anchor assembly; and
coupling a terminal ball shank to the first end of the adjustable cable to secure the adjustable cable to the anchor bolt.

17. The method of claim 14, wherein coupling the tensioning assembly to the last ball shank includes engaging the last ball shank with a slot defined in a tensioning bolt of the tensioning assembly.

18. The method of claim 14, wherein the modular rail is a stair lift rail configured to support a stair lift.

19. The method of claim 14, wherein the anchor assembly includes an anchor bolt and a nut threaded onto the anchor bolt, wherein adjusting the anchor assembly includes:
threadably moving the nut along the anchor bolt to adjust the slack from the adjustable cable.

20. The method of claim 14, wherein the tensioning assembly includes a tensioning bolt and a nut threaded onto the tensioning bolt, wherein adjusting the tensioning assembly includes:
threadably moving the nut along the tensioning bolt to adjust the tension in the adjustable cable.
